(19) United States
(12) Patent Application Publication
(10) Pub. No.: US 2002/0062449 A1
(43) Pub. Date: May 23, 2002

(54) System and method for application-level security

(76) Inventors: James De Perna, Randolph, NJ (US); Izabella Galinsky, Summit, NJ (US); Lenard Gassman, Fort Lee, NJ (US)

Correspondence Address: MCDERMOTT WILL & EMERY, 600 13TH STREET, N.W., WASHINGTON, DC, 20005-3096, US

(21) Appl. No.: 09/988,009

(22) Filed: Nov. 16, 2001

Related U.S. Application Data
(60) Provisional application No. 60/248,569, filed on Nov. 16, 2000.

(51) Int. Cl. G06F 12/14; G06F 12/00

(52) U.S. Cl. 713/200; 711/163; 707/9

(57) ABSTRACT

Software applications having a hierarchy of functions, sub-function and sub-sub-functions that are made available to one or more clients. The ability of the clients to utilize the various functionality of the applications is controlled by an application security database system (ASDS) which maintains a database of application function hierarchy and client entitlements. The applications consult with the ASDS to determine whether a client's user is authorized to perform a requested function and either performs, or fails to perform, the requested function based on the reply from the ASDS. In particular, rules regarding access to proprietary data associated with different functionality are also maintained by the ASDS. The client entitlements are associated with the end-users of the clients not by user name but, rather, by user roles reflecting the business structure of the client.

### RELATED APPLICATIONS

This application relates to and claims priority from Provisional U.S. Application Serial No. 60/248,569 filed Nov. 16, 2000 entitled APPLICATION SECURITY DATABASE, the disclosure of which is hereby incorporated in its entirety by reference.

### FIELD OF THE INVENTION

The present invention relates to a computer software application and more particularly to an application for protecting software applications and their underlying proprietary data.

### BACKGROUND OF THE INVENTION

Security of computing resources is an ever-growing concern, especially in today's distributed computing environment in which user's can attempt to access resources from various geographical locations.

One type of security application software functions by restricting user's abilities to access physical resources. For example, use of certain terminals may be prohibited, use of certain disk drives may be restricted, and the use of certain printers and other output devices can be prevented. These types of systems provide gross levels of selectivity when prohibiting access to resources.

Many modem operating systems now provide security features which try to prevent unauthorized activity at a finer level of selectivity. Within a physical device, for example, a user may be prohibited from executing certain programs, seeing various directory listings, or overwriting particular files. These types of security benefits have a number of drawbacks. First, the secured entities are defined at the operating system level. In a file, for example, of customer account balances there are some accounts a user has a business need to access and other accounts that should be protected. At the operating system level, however, the entire file is either accessible or not. Secondly, enforcement of operating systems type security features requires that a user actually login to the computing system which is providing the resource being protected.

There is a need, heretofore unmet by conventional security applications, to protect software applications and their underlying proprietary data, particularly in a manner which grants and controls access to application functionality for a multiplicity of different organizations.

### SUMMARY OF THE INVENTION

These and other needs are met by aspects of the present invention which relates to software applications having a hierarchy of functions, sub-functions and sub-sub-functions and made available to one or more clients. The ability of the clients to utilize the various functionality of the applications is controlled by an application security database system (ASDS) which maintains a database of application function hierarchies and client entitlements. The applications consult with the ASDS to determine whether a client's user is authorized to perform a requested function and either performs, or fails to perform, the requested function based on the reply from the ASDS. In particular, rules regarding access to proprietary data associated with different functionality are also maintained by the ASDS; proprietary data is data that is sensitive in some manner (e.g., for business-related reasons, duty of confidentiality, etc.) such that unlimited access to the data should be avoided. The client entitlements are, in some embodiments, associated with the end-users of the clients not by user name but, rather, by user roles reflecting the business structure of the client. In particular, aspects of the ASDS:

a) provides a security solution to organizations whose application end-users span a large and diverse number of external clients;

b) secures software applications that run on mainframes and distributed systems;

c) segregates entitlements and administration rights by client identity;

d) performs authorization checks for an end-user who is not signed on to the operating system (i.e., the end user could be accessing a remote system);

e) grants access and authorization to applications and their functionality based upon an end-user's set of job roles;

f) provides a web-based front end to ease and simplify administration;

g) permits real-time auditing; and

h) performs changes to entitlements and their authorization settings immediately upon the administrator's action, without the need for the end-user(s) to sign-off and sign-on again to effect the change.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary environment in which embodiments of the present application security database system operate.

FIG. 2 illustrates an exemplary flowchart depicting the logical flow of an application requesting authorization for performing a particular function according to an embodiment of the present invention.

FIGS. 3-10 illustrate exemplary interface screens for administering entitlement and authorization data useful by embodiments of the present invention.

FIGS. 12A, 12B and 13 illustrate exemplary interface screens for providing auditing functions according to embodiments of the present invention.

### DESCRIPTION OF THE PREFERRED EMBODIMENT

To aid with the understanding of the present invention, exemplary embodiments are presented within the context of a specific environment involving securities trading. In general, however, the invention is applicable to other environments where a software application, or applications, is made available to one or more clients and access to the application's functionality is desired to be controlled.

### General Environment

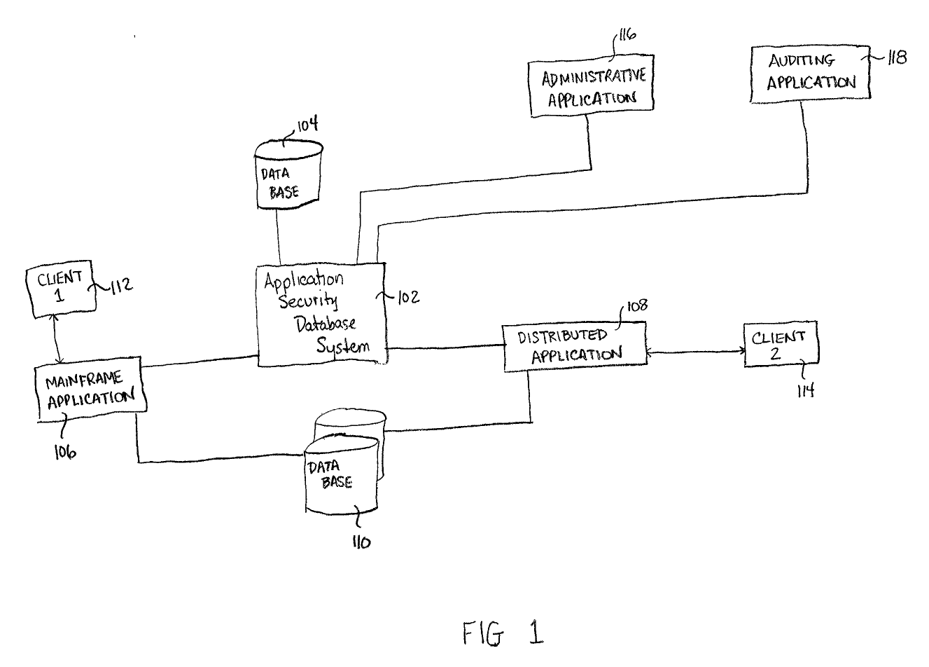

FIG. 1 shows an exemplary environment in which various aspects of the present invention can operate. In particular, software applications 106 and 108 are available for use by clients 112 and 114. These software applications can include both distributed applications 108 and applications 106 that run on a mainframe. Clients 112 and 114 interface with the applications using conventional and well-known techniques and methods. This interfacing can be accomplished using local and wide-area networks, the Internet, dedicated terminals, dial-up connections, wireless protocols, and other functionally equivalent alternatives.

In operation, the applications 106 and 108 sometimes utilize external data 110 as well as internal hard-coded data. This data 110 can include proprietary data which is locally or remotely stored, data generated on the fly from manipulating pre-stored data, as well as dynamic information such as live data feeds.

In a preferred embodiment, the clients 112 and 114 contract with a provider of the applications 106 and 108 and data 110. The clients 112 and 114 are allowed to access and utilize some or all of the features of some or all of the respective applications 106 and 108 based on particular contractual arrangements with the applications' provider. Typically a client 112 and 114 is an organization that comprises a number of individuals, or end-users. These individuals have different organizational roles and functions within the client's organization and need different aspects of the applications 106 and 108 in order to carry-out their roles. The applications 106 and 108 are, then, software tools that are made available to one or more clients 112 and 114 for use by the client's end-users. One exemplary environment is in the field of securities trading. In such an environment, the applications 106 and 108 are trading tools and applications which different investment service providers (clients 112 and 114) can access. The extent of the data and tools that are accessible by a particular client is determined by a prearranged contract.

An Application Security Database System (ASDS) 102 is a software application which communicates with the software applications 106 and 108 to help ensure clients 112 and 114 are allowed access to only those application features and data for which they are authorized. In particular, various functions and sub-functions of the applications 106 and 108 include software routines that query the ASDS 102 before performing that particular function. This type of security aspect is remotely similar, in principle, to the execution of the “1s” command, for example, in a typical UNIX environment; before displaying the requested directory listing, a portion of the software code which implements the “1s” command checks the USERID and performs the command only within the permissions granted that USERID by the operating system. Similarly, aspects of the present invention relate to custom, or customizable, applications 106 and 108 whose functions include code portions that call the ASDS 102, pass information regarding the user requesting a function, and ensure the user is only allowed to perform authorized functions according to responses returned by the ASDS 102. In particular, different operating system APIs (e.g., MVS/OS 390 APIs) and message-based services (e.g., HTTP, MQ Series, and XML format etc.) can be used for inter-program communications.

The ASDS 102 relies on a database 104 which stores information that correlates different applications and functions with different clients and users. This stored information 104 is consulted by the ASDS 102 when determining whether a requested function can be performed by the requesting user. In a preferred embodiment, the database 104 relates the functions (and sub-functions) of each application 106 and 108 in a hierarchical fashion. This design allows an administrator to suspend access to an application or some of its parts thereby affecting all clients 112 and 114 and groups of clients globally.

The ASDS 102 and its associated database 104 are administered and maintained by one or more administrators that interface with the ASDS 102 through an administration application 116. This application can preferably provide a web-based interface to allow widely distributed administrators to easily effect system maintenance and configuration regardless of physical location. Alternatively this administration application can include a workflow component whereby entitlement requests are made by end-users or their managers and the entitlement changes are automatically applied to the ASDS database 104 once all required electronic approvals have been obtained. The functions available through the administration application (e.g., adding users, deleting users, defining user permissions, viewing user permissions, defining application functions, etc.) can, themselves, utilize the security features of the ASDS 102 so that different administrators can be permitted to, or prohibited from, performing a limited subset of administrative tasks.

An auditing application 118 is also provided which communicates with the ASDS 102. This auditing application can be used for tracking information regarding attempted unauthorized activity as well as reporting other system information related to the ASDS 102. The database 104, or another auditing-specific database (not shown) can be used to store information utilized by the auditing application 118.

### Operational Logical Flow

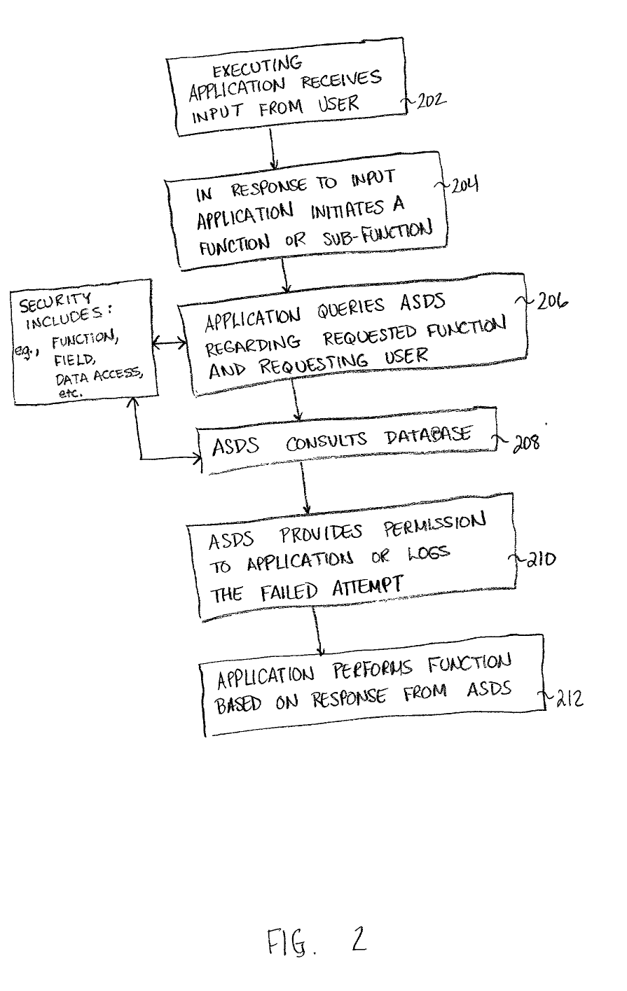

FIG. 2 illustrates a high-level flow chart of the operation of the ASDS 102. The applications 106 and 108 which utilize the ASDS 102 are assumed to have the capability to track user identity information and be comprised of functions which have security exits that contact the ASDS 102 for determining security authorization.

In step 202, the application 106, for example, receives through an interface some mouse, keyboard, audio or other type of input from the user 112. The input is initiated from a computing device (e.g., workstation, hand-help, laptop, etc.) available to the user 112 which provides output based on the operations of the application 106. In response to this input, the application 106 initiates, in step 204, performance of a function, or sub-function, as indicated by the input.

As part of performing the requested function, the application 106 provides, in step 206, the ASDS 102 with information identifying the requested function and information identifying the requesting user. The ASDS 102, in step 208, utilizes the information to consult the database 104 in order to determine whether the requesting user is authorized to perform the requested function.

If the requesting user is authorized to perform the requested function, then the ASDS 102 provides, in step 210, a message indicating such authorization to the application 106. If the requesting user is not authorized to perform the requested function, then the ASDS 102 provides, in step 210, a message indicating lack of such authorization to the application 106. In addition, the ASDS 102 logs information about the failed attempt; for example, in database 104. The logged information can include, for example, information about the date and time of the request, the requester's identity, and the requested function's identity.

The above description explicitly identifies only applications and functions within applications. However, a function can include sub-functions which, in-turn, include sub-sub-functions, etc., each of which can have their own individual authorization parameters stored in database 104. The present invention contemplates applications 106 and 108 with multiple levels of functions; however, the following detailed examples happen to describe 4 levels of functions and sub-functions for illustrative purposes only.

Furthermore, many functions provide fields of data for display and editing to a client 112. These fields, from the database 110 for example, can involve their own authorization parameters as well. Therefore, within the database 104, each function defined within an application can be defined as owning one or more fields. The application, in performing step 206, can obtain a list of all fields belonging to a requested application function that the requesting user is authorized to access. This list will instruct the calling application as to how the fields should be displayed—fully-enabled, write-protected, disabled, invisible, etc.

Based on the information the calling application 106 receives from the ASDS 102, the application 106 performs the requested function accordingly, in step 212. The result of the application 106 performing the requested function is then forwarded to the client 112 so that the client can continue using the application 106.

### The ASDS Details

The details of the ASDS 102 are discussed below based on a convenient separation into components focusing on: administration, auditing, and enforcement.

### Administration

Although depicted as a separate functional block in FIG. 1, the administrative application 116 can be a co-residing software portion of the ASDS 102. The administrative functions from application 116 are preferably made available through a GUI or other easy-to-use interface. These functions allow security administrators to list, view or maintain security settings and access entitlements (for which they are authorized).

In specifying and maintaining these security parameters, that are stored in the database 104, administrators define the following data:

Roles

Job roles are the mechanism by which application functionality is correlated to end-users at the clients 112 and 114. The administrative application 116 permits the creation of new roles and attaches them to various clients 112 and 114. Once a role has been created it can be assigned by an administrator to a particular end-user at a client.

One benefit of the ASDS 102 is the flexibility afforded to administrators. For example, the functionality to create a new role may be reserved for only administrators working for the provider of the applications 106 and 108. However, the functionality to assign end-users to a particular role can be delegated to administrators working for the client associated with that particular role. When performing certain functionality, the administrative application 116 checks with the ASDS 102 to ensure the requesting administrator has the necessary authorization. In this way, the ASDS 102 is, itself, used in its own administration.

“Roles” provide a powerful and easy mechanism for defining entitlements and are included in many of the example environments described herein. However, roles are not the only mechanism within the present invention by which application functionality is correlated with end-users. One alternative expressly contemplated within alternative embodiments of the present invention is to associate entitlements with a particular user ID. These alternatives are not mutually exclusive but can even be used conjunctively to provide the ease of modifications offered by roles-based administration while providing the finer levels of selectivity offered through user IDs.

Application Functionality

Applications 106 and 108 are considered by the ASDS 102 to be hierarchically arranged. For example, an application has functions which have sub-functions, which have sub-sub-functions, etc. These hierarchical constructs are logical in nature in that they are not necessarily distinct physical pieces of contiguous software code but are anything that the application 106 and 108 defines them to be.

For example, a sub-function can be an entire screen, a single button on a screen, or even a list box that displays data from a file. These functions can also have associated “fields” of data elements for display and updating.

Once application functions are defined and stored in the database 104, they can be enabled or disabled for all clients, for particular clients, or for selected job roles at particular clients. Accordingly, a particular job role at client 112 is not necessarily granted the same entitlements as the same job role at client 114 with respect to any particular application functionality.

Within the database 104, the hierarchical relations of the various functions are maintained. Thus, if the authorization attribute for a function is changed from “enabled” to “read-only”, then all child sub-functions (and sub-sub-functions) inherit the new “read-only” setting. Also, if a function is set to expire for a particular client (e.g. client 112) at a particular time, then that function expires for all job-roles of that client 112 that previously had access to the function.

These inheritance features enable administrators to control access at various levels and, therefore, make the administration process faster and more efficient. It is especially valuable during times when access must be permanently or temporarily taken away from different segments of the user population in a rapid fashion.

Throughout this disclosure, the term “function” is used for convenience even though it encompasses more than merely an application function. Within this disclosure, a function is intended to refer to functions, sub-functions, sub-sub-functions, proprietary data, and data fields. Essentially a function is any “secured resource” that an application controls access to through operation with the ASDS 102.

Proprietary Data

The ASDS 102 permits controlling user access to proprietary and confidential business data. For example, in a securities trading environment, client 112 can have one or more offices, each of which has one or more managers, each of which has one or more accounts (identified buy a unique account number).

These different hierarchical levels are referred to as “business parties”. If an administrator entitles a user to a business party representing the “client”, for example, then that user would obtain full access to all business parties subordinate to the “client (i.e., all offices, all managers, all accounts). Similarly, an access entitlement at the “manager” level would give full access to all data pertaining to that manager, as well as all data pertaining to the accounts “owned” by that manager. The design of the ASDS 102 allows each client to define its own organizational structure consisting of business party names. In addition, business party access entitlements can be attached to sharable, pre-defined profiles which simplify assigning to users identical data access requirements.

When an application 106 and 108 performs a function that retrieves business data, a number of techniques are possible for enforcing the entitlements permissions. For example, the application 106 and 108 can invoke SQL “joins” between the business data 110 and the permissions database 104 so as to limit data retrieval to only those clients, offices, managers, accounts that the user is capable of accessing. Alternatively, the applications 106 and 108 can include specific routines within particular functionality that queries the ASDS 102 regarding certain requested data. For example, the application 106 and 108 can query the ASDS 102 questions such as “Can user XXXX access data for account YYYY?”

The present invention explicitly contemplates that there may be special accounts that require special access permission. These accounts can be designated such that access to them is not automatically authorized based on the “business party” system described above.

User Information

Through functionality for setting-up new users, security administrators can create new users, purge existing users, reset passwords, modify user attributes (e.g., name, ID number, client number, etc.).

### Exemplary Screens

A series of interface screens are described below which illustrate an exemplary interface that permits an administrator to define and maintain authorization settings in the ASDS 102. The present invention is not limited to the specific screen layout or screen fields depicted herein but contemplates within its scope those variations and alternatives within the skill and understanding of an artisan in this field. From these screens the data that is stored in database 104 is created, modified and maintained to facilitate the functioning of the ASDS 102.

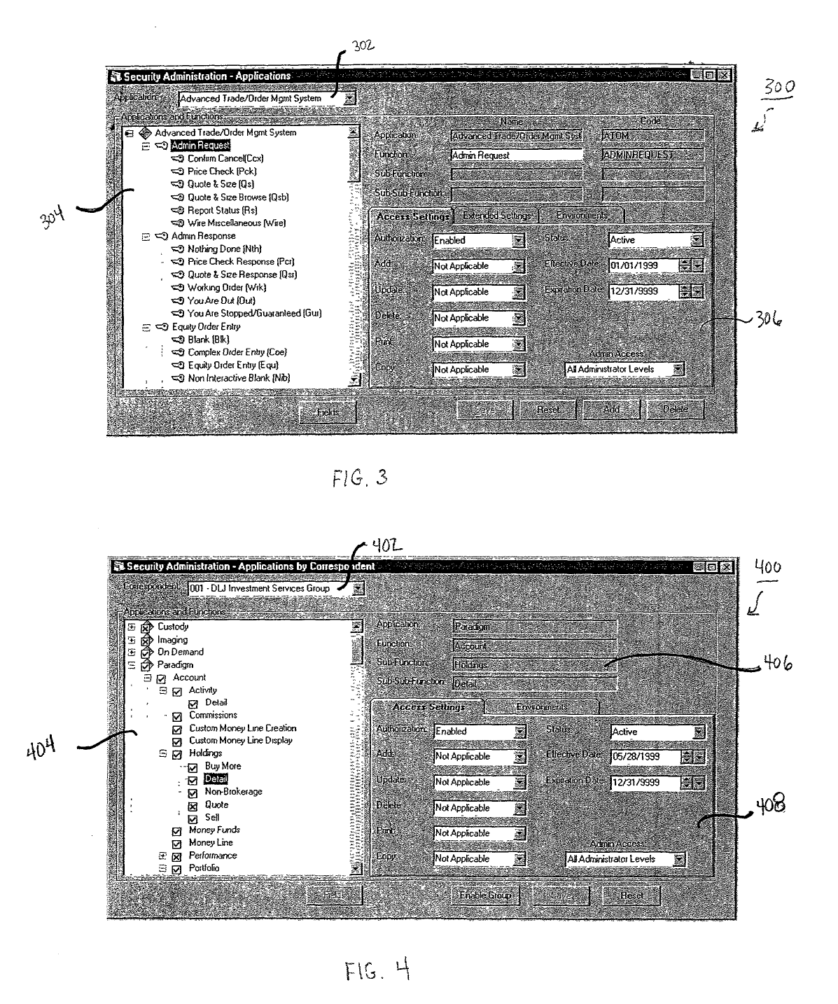

FIG. 3 depicts an exemplary interface screen 300 for administering an application. From this screen an administrator can define the functions and sub-functions associated with an application as well as administer the entitlement settings at the application-level (i.e., these settings define the entitlement framework in which all other settings for this application must work within). In this particular example, text box 302 identifies the application as “Advanced Trade/Order Mgmt System” while the sub-window 304 displays the hierarchical arrangement of the functions and sub-functions within the application. The portion 306 of the screen 300 permits the entitlements to be set for the function “Admin Request”.

FIG. 4 depicts an exemplary interface screen 400 for administering entitlements to an application based on the client. From this screen an administrator can define the particular entitlements a particular client is permitted with respect to a particular application. In text box 402, the client's name “DLJ Investment Services” is shown. Below that box, in sub-window 404, a hierarchically arranged list of applications and functions is graphically arranged to permit an administrator to easily select a function to administer. In text region 406, the hierarchical arrangement of the selected function is depicted in a non-graphical manner and dialog box 408 provides selections for the administrator to set access authorizations for the selected function “Detail”.

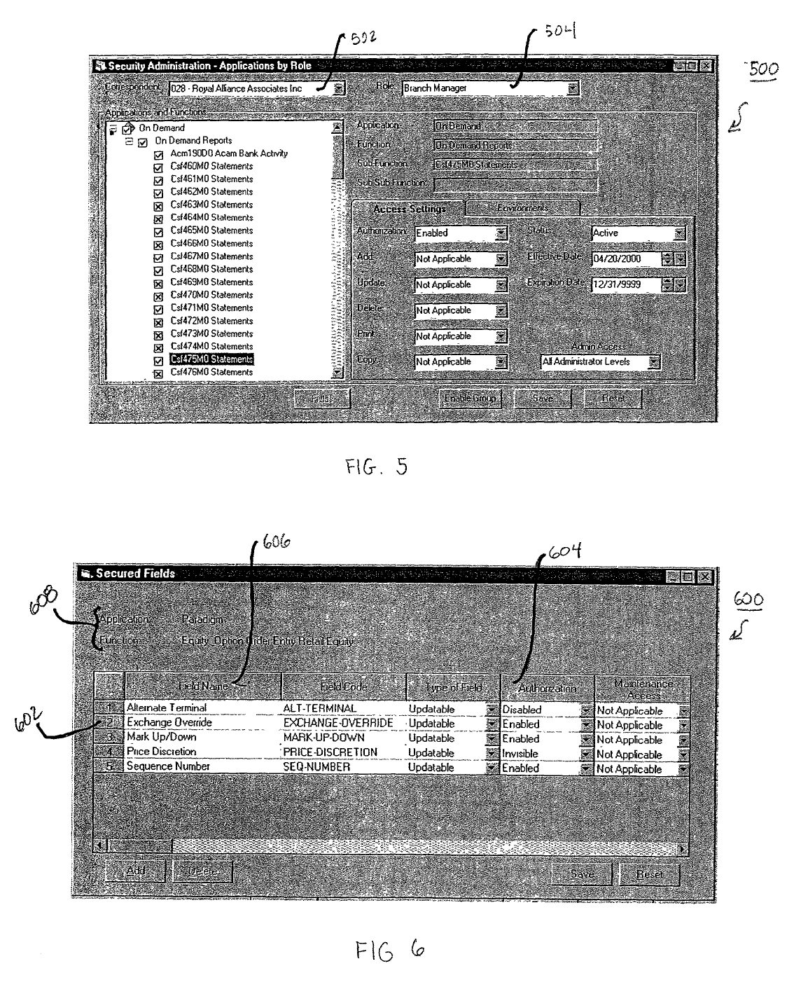

FIG. 5 depicts an exemplary interface screen 500 that permits the administering of entitlements to an application based on a particular job role. Similar to the previous screens, the application hierarchy is depicted as well as a setting screen that allows the actual settings to be made. However, in this screen 500, the defined entitlements are associated with a particular job role 504 and a particular client 502.

FIG. 6 depicts an exemplary interface screen 600 for administering data fields. From this screen 600, an administrator can define those fields 602 associated with an application (e.g., Paradigm) and function 608 (e.g., Equity -Option Order Entry Retail Equity). The field names are listed in the leftmost column 606 and the particular authorization settings are changeable via an “Authorization” column 604. The interface screen 600 can be reached via any of the previous interface screens so that the field entitlements can be specified according to application, client or role (or a combination).

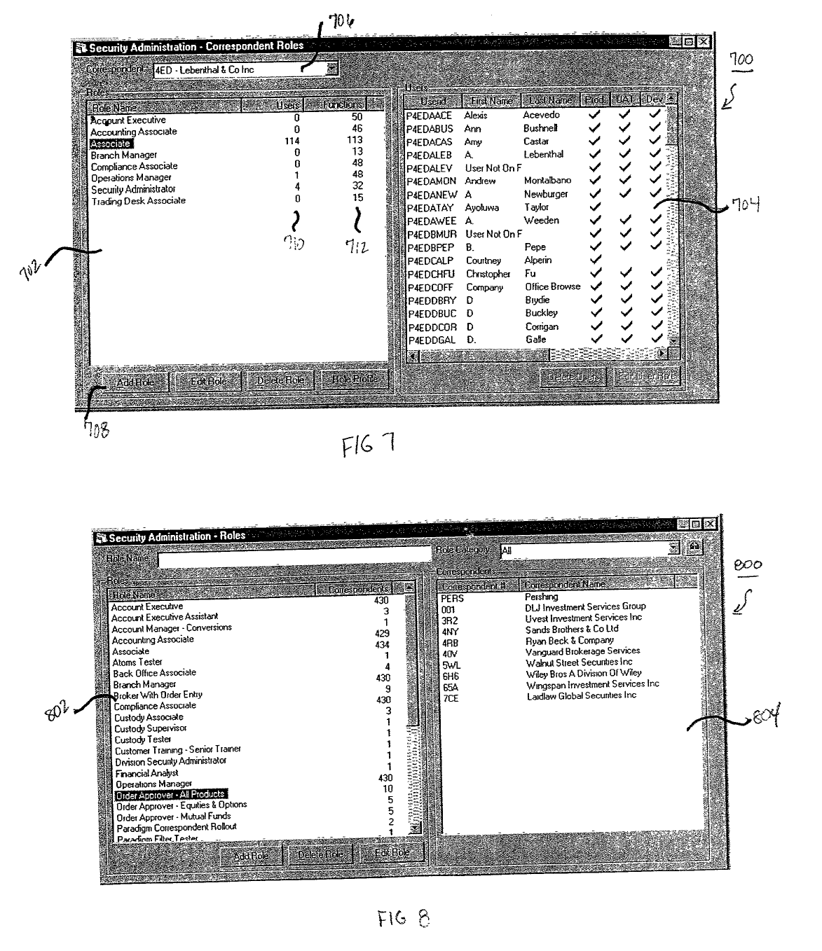

FIG. 7 depicts an exemplary interface screen for associating roles with a client. The client 706 has associated therewith various roles, listed in window 702, that can be administered (e.g., added, deleted, edited, etc.) using the controls 708. User information relating to the client's users can also be provided in sub-window 704. FIG. 8 shows a slight variation in which a particular role can be selected from the variety of different roles 802 in order to display 804 the names of all the clients who are associated with that particular role.

FIG. 9 depicts an exemplary interface screen for administering the data access granted to a user. For a particular user 904 of a particular client 902, a table 906 is provided that displays the data access definitions for that user. The table identifies those accounts of a particular manager at a particular office of a particular client for which the user 904 has access rights. As mentioned earlier, the definition and hierarchical arrangement of these “business parties” can be delegated to the administrators at the client level so that each client can define their own hierarchy.

For example, a user who is entitled to the Midwest Region of Client ABC is also authorized to access all data belonging to entities that report into the Midwest Region (e.g., zones, district offices, sales offices, etc.). Each client can establish its hierarchical structures based upon its unique business contexts of reporting. For example, Client ABC could set up two separate hierarchical structures—one for revenue reporting and one for expense reporting. A user can then be entitled to access a level of the hierarchy (e.g., Midwest Region) for the purposes of revenue type data, but would not necessarily have access to expense type data belonging to that level. At a more granular level, the entitlements for accessing proprietary data can be depend on the application 106 and 108 or even the specific functions within an application. In this manner, a user can be authorized different levels of access to proprietary data among the different applications 106 and 108 as well as among the different functions within a particular application.

When an application 106 and 108 calls the ASDS 102 to inquire about a user's access to proprietary data, the application 106 and 108 needs only provide the “business party” level being checked and does not have to provide all the levels which are parents and children of the level being checked. The ASDS 102 can interface with an organizational chart database or other data indicating the parent-child arrangements (provided by the client) and perform all the processing necessary to determine the parent-child relationships of the hierarchy.

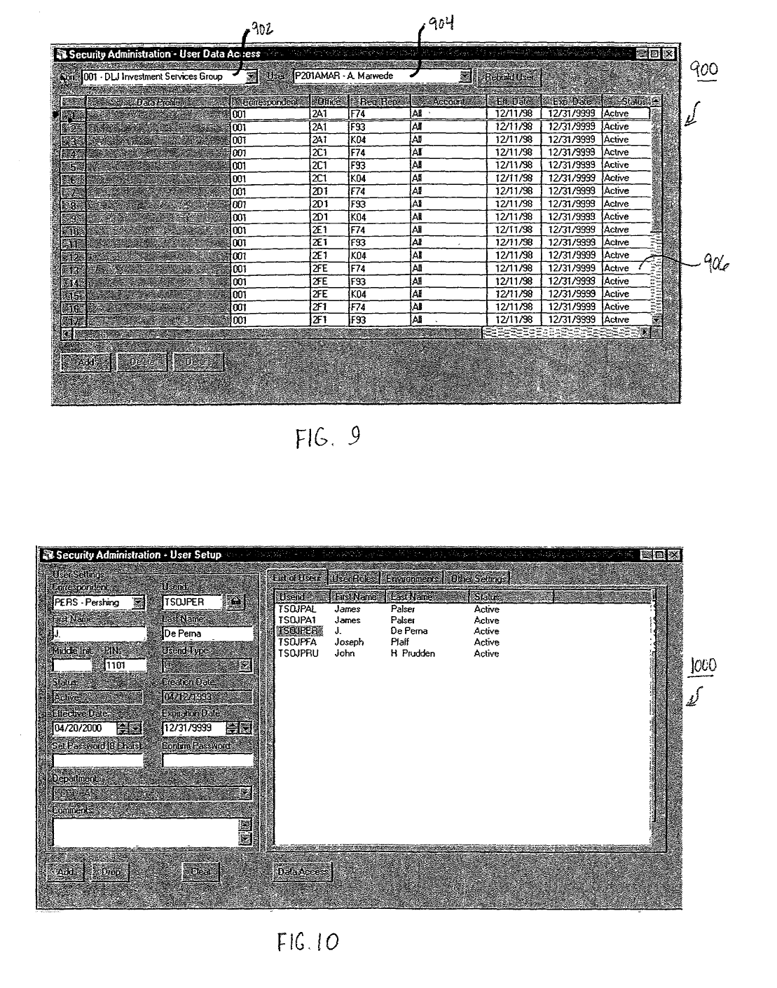

FIG. 10 depicts an exemplary screen 1000 for setting-up user information. Through this screen an administrator can create a new user, delete an existing user, or modify a user's attributes. FIG. 11 depicts the same screen 1000 but after the Tab 1102 is selected so that the user's roles can be administered. From this screen, an administrator can associate one or more roles with a user. As shown, the user of screen 1000 has at least four different roles that are considered by the ASDS 102 when determining entitlements and authorizations to application 106 and 108.

### Security Auditing

Through the use of the auditing application 118, administrators or security auditors can query the database 104 in order to investigate the settings of the ASDS 102 from a number of different perspectives and a history of its performance with respect to the application 106 and 108 and with respect to the clients 112 and 114.

In particular, an auditor utilizes the auditing application 118, to query the database 104 (through the ASDS 102) for the purpose of producing lists of entitlements from the perspective of the application 106 and 108, from the perspective of the client 112 and 114, from the perspective of the different roles, or from the perspective of a user name or user ID. Also, a history function within application 118 can provide a list of security violations data and a list of changes to entitlements. These different lists and queries can be refined by allowing the auditor to restrict the lists according to different fields and, furthermore, these lists can be output to printers or exported to other software applications to aid in the viewing and diagnostics associated with the lists.

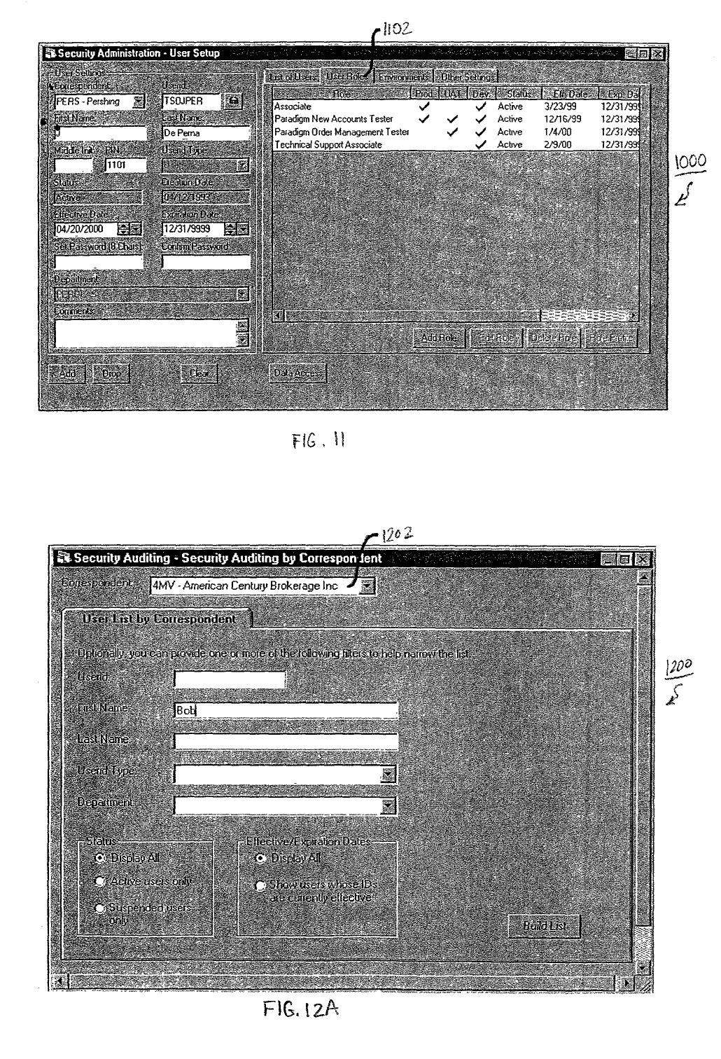

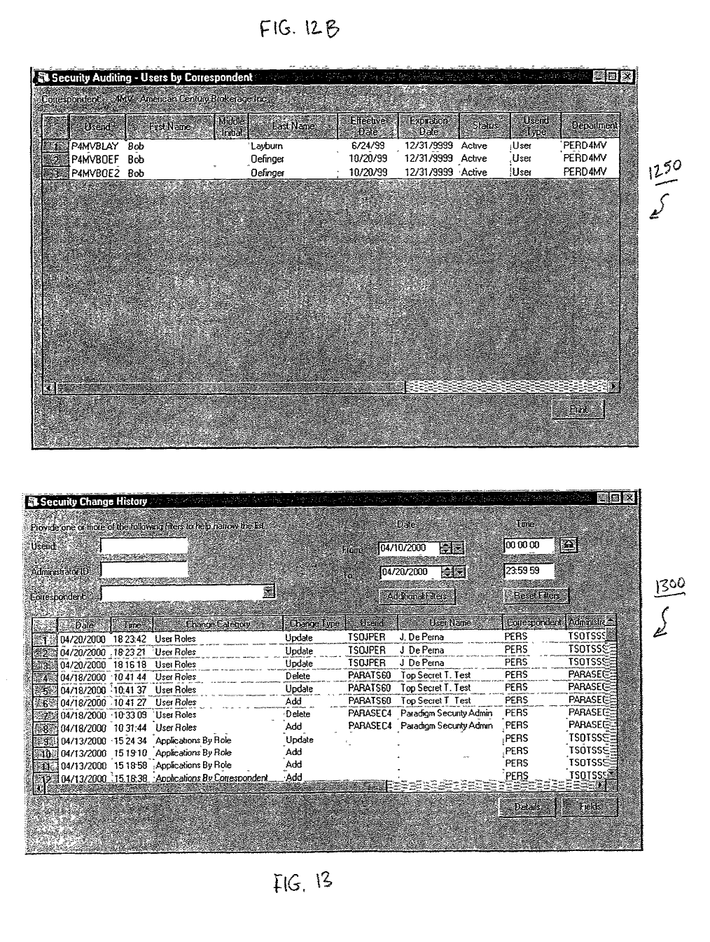

FIG. 12A depicts an exemplary query screen 1200 which allows an auditor to generate a security audit list according to client name 1202. The auditor has, in this example, also selected to limit the list to only those user's named “Bob” at the client 1202. FIG. 12B depicts an exemplary audit list 1250 that might be produced based on the query of FIG. 12A. Although all fields are not explicitly depicted on the list 1250, the auditor can view user data associated with those users satisfying the search criteria.

FIG. 13 depicts an exemplary screen 1300 that shows a log of all changes to the entitlements data within the database 104. Useful information such as date/time, administrator's name, user's name, type of change, etc. is provided to the auditor. A similar screen can be provided by the ASDS 102 through the auditing application 118 which lists all the security violations that have been logged.

One benefit from the ASDS design for the auditing application 118 is that real-time data is available for review (preferably via a simple web-based interface). Because the ASDS 102 logs user security violations and administration activities as they occur, this data is available instantaneously after the violation or activity has been captured by the system. The logged data includes all relevant details about the activity or violation and these details can be used as filters, or search parameters, so that data can be selected according to User ID, Client name, Administrator ID, date and time, type of violation, type of activity, etc. Administrators and auditors using administrative application 116 and auditing application 118, respectively, can benefit from the availability of real-time logs to monitor the state of the ASDS 102.

### Security Enforcement

As described earlier with reference to FIG. 2, application 106 and 108 embed calls to the ASDS 102 in order to ascertain a user's ability to access application functionality, secured fields and proprietary business data. Similarly, the administrative application 116 and the auditing application 118 also embed calls to the ASDS 102 in order to assess an administrator's ability to access certain screens and modify certain settings. In exemplary embodiment, the database 104 of the ASDS 102 includes a number of tables managed by a relational database management system. These tables store the information and data depicted in the previously described interface screens and have appropriate key fields such as function, or client, or user name, or role so that the various tables can be consulted by the ASDS 102 in order to determine a requesting user's entitlements.

### Additional Features

Security By Roles

Through the use of ASDS 102, a manager at client 112 and 114 can create a job role that explicitly defines the scope of responsibilities for client employees. Once this role is defined, an administrator can attach one or more application functions to the role. Employees of the client 112 and 114 who are assigned this job role will automatically be granted access to the applications and functionality defined under this role. Thus, the security determinations and decisions do not need to be repeated for every new employee that arrives, or every employee job change, at a client 112 and 114. An unlimited number of users can be assigned to one role, and an unlimited number of applications and functions can be entitled to one role. Since a role is associated with a specific client, it can be controlled independently without affecting other clients.

Real Time Entitlement Changes

Due to the relational database architecture of ASDS 102, administrative changes to entitlements and their authorization settings take effect immediately upon the administrator's actions, without the need for the end-user to sign-off and sign back on the system.

Entitlement Listings

Some applications 106 and 108 may find it beneficial if the ASDS 102 can, instead of providing a simple “yes” or “no” authorization answer, provides a listing of all the functions, sub-functions, fields, proprietary data, etc. that a user is authorized to access. For example, the application 106 and 108 can have the capability of building dynamic toolbars or cascading menus. Rather than requiring the application 106 and 108 to query the ASDS 102 regarding each possible function, the application 106 and 108 can query for a “listing”. In return, the application 106 and 108 is provided a list of the user's authorized entitlements within the calling application. Of particular benefit is that this listing of entitlements does not necessarily include the entirety of the entitlements granted to the user which are stored in database 104. Because of the manner in which the ASDS 102 associates entitlements among, users, roles, functions, applications, etc. within the relational database 104, the calling application 106 and 108 can include filtering parameters (e.g., filtered according to combinations of specific roles, specific applications, specific access levels, specific functions, etc.) within the query for a listing so that the entitlements returned to the application in the listing are only those entitlements matching the filtering parameters.

Authorization Simulator

Many conventional security products require an application user to be logged into the system hosting the security product. Troubleshooting authorization errors (e.g., at a help desk) is made essentially impossible because the help-desk personnel is logged in under their own user ID and cannot re-create the security environment of the end user. The design of the ASDS 102 permits simplified troubleshooting for an administrator or auditor. A custom troubleshooting application permits the administrator to input a specific user Id and a specific application, function or proprietary data name and then simulates a call from the problematic application using the inputted parameters. The ASDS 102 recognizes the call as a simulation and provides an authorization message in return that allows simple diagnosis of problems reported by endusers. Violations that occur during a simulation are not logged in the database 104.

While this invention has been described in connection with what is presently considered to be the most practical and preferred embodiment, it is to be understood that the invention is not limited to the disclosed embodiment, but on the contrary, is intended to cover various modifications and equivalent arrangements included within the spirit and scope of the appended claims. The invention is capable of other and different embodiments and its several details are capable of modifications in various obvious respects, all without departing from the invention. Accordingly, the drawings and description are to be regarded as illustrative in nature, and not as restrictive.

What is claimed is:

1. A system for limiting access to the functionality of one or more software applications, comprising:
a first memory configured to store first data related to each of the one or more software applications;
the first memory further configured to store second data related to each of one or more users of any of the software applications; and
a rules checker in communication with the software applications and the first memory, said rules checker configured to:
receive at least one query, said query originating from any particular one of the software applications, and
forward a message to the particular software application in response to the query;
wherein said message provides instructions to the particular software application regarding entitlements of one of the users to access a particular function of the particular software application.

2. The system according to claim 1, wherein the first memory is a relational database.

3. The system according to claim 1, wherein the each of the one or more software applications are implemented on one of a mainframe and a distributed computing system.

4. The system according to claim 1, further comprising:
a second memory configured to store proprietary data useful to the particular software application, and
wherein said message provides information to the particular software application regarding authorization to output portions of the proprietary data.

5. The method according to claim 1, wherein the respective first data for each software application includes an identification of hierarchically arranged functions associated with that software application.

6. The method according to claim 5, wherein the query further comprises information relating to the one of the users and relating to at least one of the functions associated with the particular software application, and
wherein the message relates to that one user's authorization to access the at least one function.

7. The system according to claim 5, wherein the identification of hierarchically arranged functions include functions, sub-functions, and sub-sub functions.

8. The system according to claim 1, wherein the respective first data for each software application includes an identification of data fields associated with that software application.

9. The system according to claim 8, wherein the query further comprises information relating to one of the users and relating to at least one of the data fields associated with the particular software application, and
wherein the message relates to that one user's authorization to access the at least one field.

10. The system according to claim 1, wherein the rules checker is further configured to:
generate the message based on the query, the first data and the second data.

11. The system according to claim 1, wherein:
the respective second data for each of the users includes at least one role, from among a plurality of roles, associated with that particular user, and
the respective first data for each software application includes:
an identification of hierarchically arranged functions associated with that software application, and
an description of which of the plurality of roles is entitled to access each of the functions.

12. The system according to claim 11, wherein:
the query includes an identification of a specific one of the users and a specific one of the functions associated with the particular software application;
the rules checker is further configured to generate the message based on the query, the first data and the second data; and
the message instructs the particular software application regarding that specific user's entitlement to access that specific function.

13. The system according to claim 12, wherein the rules checker logs data relating to an instance in which the specific user is not entitled to access that specific function.

14. The system according to claim 4, wherein the respective second data for each of the users includes an access level from among a plurality of access levels, associated with that particular user, said access level determining an authorization of that particular user to access proprietary data within the second memory, and
the rules checker is further configured to generate the message based on the query, the first data and the second data.

15. The system according to claim 1, further comprising:
an administrative application configured to facilitate administration of the first and second data.

16. The system according to claim 15, wherein the administrative application is further configured to manipulate the first data according to which of a plurality of clients one or more of the users is associated with.

17. The system according to claim 15, wherein the administrative application is further configured to manipulate the first data according to an identity of a particular one of the users.

18. The system according to claim 15, wherein the administrative application is further configured to manipulate the first data according to which of a plurality of roles a particular one of the users is associated with.

19. The system according to claim 15, wherein the administrative application is further configured to manipulate all the first data relating to a specific one of the software applications.

20. The system according to claim 15, wherein the administrative application is further configured to manipulate all the first data relating to one of a plurality of functions associated with a specific one of the software applications.

21. The system according to claim 1, further comprising:
an auditing application configured to facilitate auditing of the first and second data and any additional data generated by the rules checker.

22. The system according to claim 21, wherein the auditing application is further configured to provide a history, upon request, of messages forwarded by the rules checker.

23. The system according to claim 22, wherein the history emphasizes those messages related to a failed attempt to access the particular function.

24. The system according to claim 22, wherein the auditing application is further configured to provide a history, upon request, of changes to one or both of the first data and the second data.

25. A method for providing application-level security, said method comprising the steps of:
storing first data relating to a plurality of software applications;
storing second data relating to a plurality of users of the software applications;
receiving a query from a particular one of the software applications;
in response to the query, forwarding a message to the particular software application, said message providing instructions to the particular software application regarding entitlements of a particular user to access a function of the particular software application.

26. The method according to claim 25, further comprising the step of:
generating the message based on the query, the first data and the second data.

27. The method according to claim 26, wherein the query includes an identification of the particular user and the function.

28. The method according to claim 25, wherein the second data includes for each user, one or more of an associated user ID, client name, role, and business level.

29. The method according to claim 28, wherein the first data includes for each software application an identification of associated hierarchically arranged functions and characteristics of those users authorized to access each such function.

30. The method according to claim 29, further comprising the steps of:
correlating the first and second data to determine authorized functions, said authorized functions being those particular functions of each software application which are accessible by a specified user;
generating the message based on the query and the determination of authorized functions, wherein said query includes an identification of the particular user and the function.

31. The method according to claim 28, wherein the first data includes for each software application an identification of associated data fields and characteristics of entitlements of users to each data field.

32. The method according to claim 31, further comprising the steps of:
correlating the first and second data to determine authorized data field operations, said authorized operations being those particular operations of each data field which are permitted to a specified user; and
generating the message based on the query and the determination of authorized operations, wherein said query includes an identification of the particular user and of a predetermined data field.

33. The method according to claim 29, further comprising the steps of:
storing proprietary data useful to one or more of the software applications; and
storing third data relating to accessibility of the proprietary data.

34. The method according to claim 33, further comprising the steps of:
correlating the first, second and third data to determine authorized data accesses, said authorized data accesses being those particular data accesses of the proprietary data which are permitted to a specified user; and
generating the message based on the query and the determination of authorized data accesses, wherein said query includes an identification of the particular user and of predetermined proprietary data.

35. The method according to claim 25, further comprising the step of:
creating a log entry relating to the message if the message indicates instructions which prohibit the particular software application access to the function.

36. The method according to claim 29, further comprising the step of:
administering the first and second data by manipulating one or both of the first and second data according to which of a plurality of clients one or more of the users is associated with.

37. The method according to claim 29, further comprising the step of:
administering the first and second data by manipulating one or both of the first and second data according to the identity of a particular one of the users.

38. The method according to claim 29, further comprising the step of:
administering the first and second data by manipulating one or both of the first and second data according to which of a plurality of roles one or more of the users is associated with.

39. The method according to claim 29, further comprising the step of:
administering the first and second data by manipulating all the first data relating to a specific one of the software applications.

40. The method according to claim 29, further comprising the step of:
administering the first and second data by manipulating all the first data relating to one of a plurality of functions associated with a specific one of the software applications.

41. A computer readable medium bearing instructions for providing application-level security, said instructions being arranged to cause one or more processors upon execution thereof to perform the steps of:
storing first data relating to a plurality of software applications;
storing second data relating to a plurality of users of the software applications;
receiving a query from a particular one of the software applications;
in response to the query, forwarding a message to the particular software application, said message providing instructions to the particular software application regarding entitlements of a particular user to access a function of the particular software application.

41. The system according to claim 14, further comprising:
a non-volatile data store indicating a hierarchical arrangement of the plurality of access levels, and
wherein the rules checker is further configured to consult the data store when determining the authorization of that particular user.

42. The system according to claim 21, wherein the auditing application is further configured to provide real-time data logging and retrieval.

43. The system according to claim 2, wherein any updates to data within the relational database are performed in real-time and the rules checker is further configured to use the updated data.

44. The system according to claim 1, wherein the particular software application is a simulation application, said simulation application is configured to:
provide in the query to the rules checker a simulated user identity and a simulated secured resource identity;
receive from the rules checker the message forwarded by the rules checker; and
determine the entitlements of the simulated user to access the simulated secured resource.

45. The system according to claim 5, wherein the query requests a listing of entitlements for the one user, said listing identifying the entitlements for every function associated with the one user, and wherein the message includes said listing.

46. The system according to claim 45, wherein query includes filtering parameters such that the listing includes only those entitlements which satisfy the filtering parameters.

47. The system according to claim 46, wherein the filtering parameters specify one or more of a user role, a function identity, an application identity, a user identity, and a data access level.

48. The system according to claim 14, wherein the authorization of the particular user to access proprietary data depends, at least in part, on the particular software application identity.

49. The system according to claim 14, wherein the authorization of the particular user to access proprietary data depends, at least in part, on the particular function identity.
